(19) United States
(12) Patent Application Publication
(10) Pub. No.: US 2019/0251944 A1
(43) Pub. Date: Aug. 15, 2019

(54) System and Method For Altering Sound Waves

(71) Applicant: RAYMOND SOBOL, Kelowna (CA)

(72) Inventor: RAYMOND SOBOL, Kelowna (CA)

(21) Appl. No.: 16/262,899

(22) Filed: Jan. 30, 2019

Related U.S. Application Data
(60) Provisional application No. 62/624,612, filed on Jan. 31, 2018.

(51) Int. Cl. G10K 11/178

(52) U.S. Cl. CPC G10K 11/178

(57) ABSTRACT

A sound cancelling apparatus including a tensioned wire for generating a noise cancelling sound.

### CROSS-REFERENCE TO RELATED APPLICATIONS

This application claims priority to U.S. Provisional Application No. 62/624612, which was filed on January 31, 2018, and entitled “System and Method for Altering Sound Waves.” The forgoing application is incorporated herein by reference in its entirety.

### BACKGROUND OF THE INVENTION

Referencing World Health Organization, “Environmental noise exposure is responsible for a range of health effects, including increased risk of ischaemic heart disease as well as sleep disturbance, cognitive impairment among children, annoyance, stress-related mental health risks, and tinnitus.” And also, “Hearing loss is on the rise. Unless this trend is reversed, it will mean higher direct costs for health systems . . . this would be detrimental not only for individuals in terms of social isolation and increased poverty, but also for societies as a whole, due to lower productivity. A number of governments around the world have recognized the importance of mitigating current trends by preventing hearing loss in the first instance.”

Referencing Wikipedia, “Active noise control (ANC) also known as noise cancellation, or active noise reduction (ANR), is a method for reducing unwanted sound by the addition of a second sound specifically designed to cancel the first.” And, “Modern active noise control is generally achieved through the use of analog circuits or digital signal processing. Adaptive algorithms are designed to analyze the waveform of the background aural or nonaural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise.” Generally, active noise control as it is currently employed is effective in small areas such as the user's ears for headphones and for hearing aids, and ineffective at larger disperse areas. Using active noise control in hearing aids is in addition to their use for amplifying frequencies for hearing impaired.

When a first sound wave meets an inverted (or antiphase), second sound wave that is equal in both frequency and amplitude, the first and second sound waves effectively cancel each other out. Similarly, when a first sound wave meets a second sound wave with either less or more frequency and amplitude, the first wave is either reduced or amplified accordingly. Such a phenomenon is well understood.

When a current drives a particular frequency is connected to a tensioned conductor that is passing between the poles of a magnet a periodic force perpendicular to the conductor and the magnetic field is produced. Such a phenomenon is well understood.

The vibrating tensioned conductor as described in [0006] emits a sound wave, defined by the frequency and amplitude forces of the current and magnetic field.

Altering the forces of the current and or the magnetic field alters the sound wave that the vibrating tensioned conductor emits.

What is needed is a system to use Active Sound Control to predictably and actively alter sound waves so as to decrease or increase sound level exposure in both small, medium and large areas where sound wave control is needed.

### SUMMARY OF THE INVENTION

According to various implementations of the invention an electronic circuit system including a microphone or microphones (and or transducer or transducers and or frequency measurement module or modules and or wave amplitude measurement module or modules) that convert sound waves into electrical signals, a microprocessor, software, algorithm, instructions, operating system, memory, frequency wave generator module or modules, wave amplifier module or modules, WIFI module, power supply and conductor grid system consisting of tensioned conductors arranged generally in parallel and with each conductor passing between the poles of a magnet, may be configured to measure sound waves directed toward a conductor grid system or multiple conductor grid systems, generate equally inverse or modified inverted sound wave or sound waves synchronized onto the conductor grid system to meet the sound waves directed toward the conductor grid system to either completely or partially alter the sound waves.

According to various implementations of the invention an electronic circuit system may include multiple microphones, single or multiple frequency wave generator modules, single or multiple wave amplifier modules, a single or multiple conductor grid systems consisting of conductors generally in parallel, tensioned and positioned between the poles of a magnet, a WIFI module a power supply a microprocessor system and operating system, memory, software, algorithms, instructions, etc.

According to various implementations of the invention an electronic circuit system and in particular the conductor grid system may be in direct first contact with sound waves directed toward the conductor grid system 400A or systems or may be located behind a material or materials that are in first contact with sound waves directed toward a conductor grid system 400A or systems.

According to various implementations of the invention an electronic circuit system may include a single or multiple frequency measurement modules and a wave amplitude measurement module or modules, either with or without single or multiple microphones.

The foregoing is intended to be merely a summary, and not for limiting the scope of the present specification. The features of the invention that are believed to be novel are set forth with particularity in the Claims. The invention, together with further objects and advantages thereof, may best be appreciated by reference to the following detailed description taken in conjunction with the referenced drawings.

### BRIEF DESCRIPTION OF THE DRAWINGS

FIG. 1 illustrates a circuit system according to various implementations of the invention.

FIG. 1

| | |
|---|---|
| 100 | microphone |
| 150 | frequency measurement module |
| 200 | microphone |
| 250 | wave amplitude measurement module |
| 300 | magnets |
| 400A | conductor grid system |
| 500 | microprocessor system |
| 600 | operating system, memory, software, algorithms, |
| | instructions, etc. |
| 610 | frequency wave generator module |
| 620 | wave amplifier module |
| 700 | WIFI module |
| 800 | power supply |
| 900 | electronic circuit |

FIG. 2 illustrates a circuit system according to various implementations of the invention.

FIG. 2

| | |
|---|---|
| 100, 101 | microphone |
| 200, 201 | microphone |
| 300 | magnets |
| 400A | conductor grid system |
| 400B | conductor grid system |
| 500 | microprocessor system |
| 600 | operating system, memory, software, algorithms, |
| | instructions, etc. |
| 610 | frequency wave generator module |
| 620 | wave amplifier module |
| 700 | WIFI module |
| 800 | power supply |
| 901 | electronic circuit |

### DETAILED DESCRIPTION

Various implementations of the invention are directed towards altering sound waves. It is well understood that the speed of sound waves in air is affected by temperature, pressure, humidity, density, gravity, wind, physical obstructions and other sound waves. Generally, the speed of sound in air is approximately 343 meters per second. While the present invention is susceptible to embodiments in various forms, there is provided detailed description of the presently preferred embodiments, with the understanding that the present disclosure is to be regarded as exemplifications and does not limit the invention to the specific embodiments illustrated. In some instances, for purposes of explanation and not for limitation, specific numbers, diagrams, or dimensions, etc., may be set forth in order to provide a thorough understanding of the invention. In other instances, detailed descriptions of well-known elements or electronic circuitry or computer/electronic and Internet components are omitted so as to not obscure the depiction of the invention with unnecessary details.

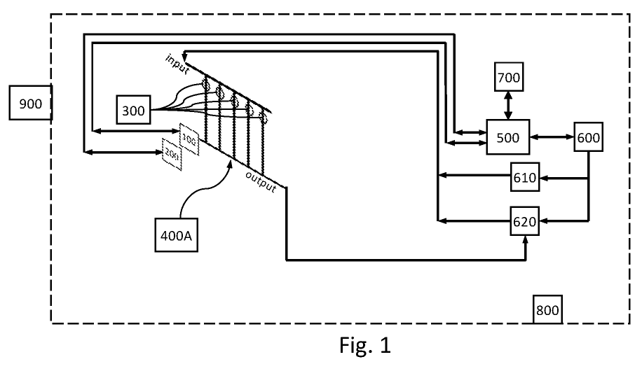

One system and method for altering sound waves is to an employ electronic circuit 900 such as that illustrated in FIG. 1. Characteristics of sound waves such as frequency, amplitude and speed may be measured using microphones 100 and 200 in close proximity to a conductor grid system 400A equipped with magnets 300 that together may be activated with inverted characteristics of the sound waves such as frequency and amplitude driven by frequency wave generator module 610 and wave amplifier module 620, WIFI module 700, all monitored and controlled by a microprocessor system 500, operating system, memory, software, algorithms and instructions 600, and powered by a power supply 800, all together the electronic circuit 900 .

The system and method described in [0018] and in particular conductor grid system 400A is preferably located between a source of unwanted sound waves and an area where sound wave alteration is preferred.

The system and method described in [0018) may be located in first contact with sound waves directed toward a conductor grid system 400A or systems or may be located behind a material or materials that are in first contact with sound waves directed toward a conductor grid system 400A or systems.

The system and method described in [0018] and in particular the conductor grid system may be of small size as for headphones or hearing aids, or a medium size as for noise sound wave altering at construction sites, in automobiles, at industrial locations, in building walls, ceilings, floors, windows and doors, and up to large size as for sound wave altering at traffic noise barriers and in aircraft fuselage. The foregoing is provided as example uses for the electronic circuit and is not limited to the above described examples.

Referring to FIG. 1, a system and method for altering sound waves may include an operating system, memory, software, algorithms and instructions 600, a microprocessor system 500, a conductor grid system 400A equipped with magnets 300, microphone 200, microphone 100, a frequency wave generator module 610, a wave amplifier generator module 620, a WIFI module 700, a power supply 800, all together an electronic circuit 900.

It is preferred microprocessor system 500 is programmed with operating system, memory, software, algorithms and instructions 600 as required to monitor microphone 200 and microphone 100 continuously.

It is preferred a conductor grid system 400A is made by positioning tensioned conductors generally in parallel to each other and connected to a frame at both ends of the conductors such that the frame is not conducting to the conductors.

It is preferred each tensioned conductor passes between the poles of a magnet 300 positioned at the input end of a conductor.

It is preferred a conductor grid system 400A connects each input end of a conductor to the input signal driven by both a frequency wave generator module and a wave amplifier module, and connects each output end of a conductor to the wave amplifier module.

It is preferred each conductor is tensioned between the end of the non-conducting frame. Methods to tension conductors to a frame are well understood.

It is preferred the magnet on the conductor be located in close proximity to the source of the input signal.

It is preferred each conductor is connected to microprocessor system 500 to receive frequency and amplitude based signals.

It is preferred a frequency wave generator module 610 is connected with microprocessor system 500 and operating system, memory, software, algorithms and instructions 600 to receive instructions.

It is preferred a wave amplifier module 620 is connected with microprocessor system 500 and operating system, memory, software, algorithms and instructions 600 to receive instructions.

It is preferred electronic circuit 900 includes a WIFI 700 module thus enabling remote control of frequency wave generator module, wave amplifier module, power on and off and measurements of performance, as examples.

It is preferred electronic circuit 900 is equipped with a power supply 800.

In summary, referring to FIG. 1, sound waves are detected by microphone 200 and then by microphone 100. The distance between microphone 200 and microphone 100 is known. The elapsed time the sound wave travels between microphone 200 and microphone 100 is measured. Sound wave speed between microphone 200 and microphone 100 is calculated by dividing distance by elapsed time. The distance between microphone 100 and conductor grid system 400A is known. The sound wave speed calculated between microphone 200 and microphone 100 is used for the sound wave speed between microphone 100 and conductor grid system 400A to calculate the time the sound wave makes contact with the conductor grid system 400A. Microprocessor system 500 and operating system, memory, software, algorithms, instructions 600 monitor microphones 200 and 100 continuously. As microprocessor system 500 and operating system, memory, software, algorithms, instructions 600 receive signals from microphones 200 and 100 instructions are made to frequency wave generator module 610 and wave amplifier module 620 to drive inverted frequency and amplitude signals to conductor grid system 400A, such that these signals are synchronized with the time the sound wave makes contact with the conductor grid system 400A. The system described in FIG. 1 includes a WIFI module 700 and a power supply 800 to form electronic circuit 900. The consequences of these signals are to alter the sound waves first detected by reducing frequency and amplitude to the area behind the conductor grid system 400A or increasing frequency and or amplitude in front of or behind the conductor grid system 400A.

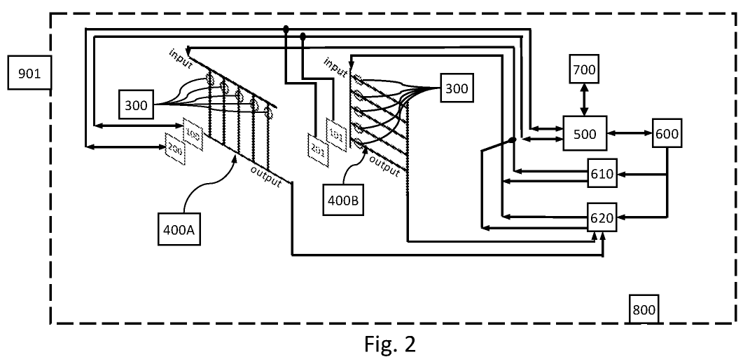

A second system and method for altering sound waves is to employ a system such as that illustrated in FIG. 2. and electronic circuit 901. Referring to FIG. 1 and paragraphs [0018] to and including [0029], a second conductor grid system 400B may be positioned behind the grid system 400A.

It is preferred conductor grid system 400B may be oriented ninety degrees compared to the orientation of conductor grid system 400A but may be oriented at any angle compared to conductor grid system 400A.

It is preferred conductor grid system 400B is located in near proximity to conductor grid system 400A, but at a different orientation, so as to increase air turbulence between conductor grid system 400A and conductor grid system 400B thereby additionally altering sound waves.

It is preferred microphone 201 and microphone 202 be located in close proximity to conductor grid system 400B.

It is preferred conductor grid system 400B is designed as and functions as conductor grid system 400A, receiving signals from frequency wave generator module or modules 610 and wave amplifier module or modules 620, except for a change in orientation.

In summary, referring to FIG. 2, sound waves are detected by microphone 200 and then by microphone 100. The distance between microphone 200 and microphone 100 is known. The elapsed time the sound wave travels between microphone 200 and microphone 100 is measured. Sound wave speed between microphone 200 and microphone 100 is calculated by dividing distance by elapsed time. The distance between microphone 100 and conductor grid system 400A is known. The sound wave speed calculated between microphone 200 and microphone 100 is used for the sound wave speed between microphone 100 and conductor grid system 400A to calculate the time the sound wave makes contact with the conductor grid system 400A. Microprocessor system 500 and operating system, memory, software, algorithms, instructions 600 monitor microphones 200 and 100 continuously. As microprocessor system 500 and operating system, memory, software, algorithms, instructions 600 receive signals from microphones 200 and 100 instructions are made to frequency wave generator module 610 and wave amplifier module 620 to drive inverted frequency and amplitude signals to conductor grid system 400A, such that these signals are synchronized with the time the sound wave makes contact with the conductor grid system 400A. Sound waves continuing to pass through grid system 400A may be detected by microphone 201 and 101 whereby sound wave speed is determined as described in [0034] to calculate the time the sound wave makes contact with conductor grid 400B. As further described in [0034] instructions are made to frequency wave generator module 610 and wave amplifier module 620 to drive inverted frequency and amplitude signals to conductor grid system 400B, such that these signals are synchronized with the time the sound wave makes contact with the conductor grid system 400B. The system described in FIG. 2 includes a WIFI module 700 and power supply 800 to form electronic circuit 901. The consequences of these signals are to alter the sound waves first detected by reducing frequency and amplitude to the area behind the conductor grid system 400A, and for sound waves that continue through conductor grid system 400A, to further alter them as they meet conductor grid system 400B.

Referring to FIG. 1 and FIG. 2, a conductor grid system 400C, conductor grid system 400D and more conductor grid systems may be sequentially added to perform as described in [0038] behind conductor grid 400B.

1. A system and method for altering sound waves comprising:
An active sound control electronic circuit system; microphones; an assembly of tensioned conductors; a frequency wave generator; a wave amplitude generator; a power supply; a WIFI module; a microprocessor; an operating system; software; algorithms; instructions.

2. A system and method for altering sound waves comprising:
An active sound control electronic circuit system; microphones; two or more assemblies of tensioned conductors affixed with magnets such that the conductor passes between the poles of the conductor; at least one frequency wave generator; at least one wave amplitude generator; a power supply; a WIFI module
a microprocessor together with an operating system, software, algorithms and instructions

3. The system and method of claim 1 wherein:
a microprocessor monitors at least two microphones for sound waves and interconnects an assembly of tensioned grid of conductors, wave amplifier module, frequency wave generator module, power supply and WIFI module
sound waves are detected by a paired set of microphones positioned one in front of the other at a set distance apart, facing the sound waves
a pair of microphones are in proximity to a known location of a tensioned grid of conductors affixed with magnets such that the conductor passes between the poles of the magnet
upon detecting sound waves at each of the microphones, time is recorded at each of the microphones is recorded while sound wave frequency and sound wave amplitude are measured at the microphone locations; speed of sound is determined
an inverted frequency and an inverted amplitude signal are delivered to the tensioned grid of conductors synchronized to the calculated time the sound wave contacts the tensioned grid or conductors

4. The system and method of claim 2 wherein:
a microprocessor monitors at least four microphones for sound waves and interconnects at least two assembled tensioned grids of conductors, wave amplifier modules, frequency wave generator modules, power supply and WIFI module
sound waves are detected by two paired sets of microphones positioned one in front of the other at a set distance apart, facing the sound waves
a first pair of microphones are in proximity to a known location of a first tensioned grid of conductors affixed with magnets such that the conductor passes between the poles of the magnet
a second pair of microphones are in proximity to a known location of a second tensioned grid of conductors
the tensioned grids of conductors are positioned one in front of the other and may be oriented ninety degrees to each other or any other angle
additional tensioned grids of conductors are similarly added
upon detecting sound waves at each of the microphones, time is recorded at each of the microphones while sound wave frequency and sound wave amplitude are measured at the microphone locations; speed of sound is determined
an inverted frequency and an inverted amplitude signal are delivered to the tensioned grid of conductors synchronized to the calculated time the sound wave contacts the tensioned grid or conductors
an inverted frequency and an inverted amplitude signal are delivered to the tensioned grid of conductors synchronized to the time the sound wave contacts the tensioned grid or conductors.
